(19) United States
(12) Patent Application Publication
(10) Pub. No.: US 2014/0207770 A1
(43) Pub. Date: Jul. 24, 2014

(54) System and Method for Identifying Documents

(71) Applicant: Flemming Madsen, London (GB)

(72) Inventor: Flemming Madsen, London (GB)

(21) Appl. No.: 13/749,397

(22) Filed: Jan. 24, 2013

(51) Int. Cl. G06F 17/30

(52) U.S. Cl. CPC G06F 17/3053; G06F 17/30699
USPC 707/730; 707/728

(57) ABSTRACT

A system for determining a similarity between a first document and a potential matching document is provided, wherein the system comprises a processor that is configured to perform steps of: determining a first identifier associated with the first document; identifying at least one potential matching document; for each document of the at least one potential matching documents: determining a second identifier; and determining a document similarity score, the document similarity score being indicative of a similarity between the first identifier and the second identifier.

### TECHNICAL FIELD

The embodiments disclosed herein relate to a system and method for identifying documents.

### BACKGROUND

Many organisations produce collateral to market their viewpoints, products and services. Such collateral may come in many forms such as white papers, documents, presentations or even blog posts or articles posted on an organisations website.

A classical problem organisations face is to distribute the collateral to the people who might find it relevant or interesting.

Traditional ways of distributing collateral are advertising, mass mailing or having potential readers subscribe to a set of fixed interests and then the mailing out of a piece of collateral is deemed to match an interest.

All of these methods suffer from a number of problems. First of all, the reader typically needs to be active in relation to the collateral, either to request it or to subscribe to it. Second the relevance to the reader is often low and third the methods do not reflect a potential readers changing interest (unless such interests are updated).

It is therefore desirable to provide an improved system and method for identifying suitable recipients of collateral that addresses at least one of the above problems.

### BRIEF DESCRIPTION OF THE DRAWINGS

The present disclosure and the embodiments set out herein can be better understood with reference to the description of the embodiments set out below, in conjunction with the appended drawings which are:

FIG. 1 is a schematic drawing of a system according to an exemplary embodiment of the invention.

FIG. 2 is a flow diagram showing a method for identifying a document.

FIG. 3 is a flow diagram showing a method for determining an identifier associated with a first document.

FIG. 4 is a flow diagram showing a method for identifying potential matching documents for the first document.

FIG. 5 is a flow diagram showing a method for determining an identifier associated with a second document.

FIG. 6 is a flow diagram showing a method for determining a document similarity score.

FIG. 7 is a schematic drawing of an exemplary embodiment of the invention

### SUMMARY OF DESCRIPTION

In a first aspect of the invention, there is provided a method of determining a similarity between a first document and a potential matching document, the method comprising: determining a first identifier associated with the first document; identifying at least one potential matching document; for each document of the at least one potential matching documents: determining a second identifier; determining a document similarity score, the document similarity score being indicative of a similarity between the first identifier and the second identifier; determining, based on the similarity score, whether the document is a match for the first document; and if the document is determined to be a match for the first document, identifying a person associated with the matching document as a recipient for the first document. In this manner, people associated with, or linked to, documents similar to a first document can be identified. For example, the person associated with the matching document may be one or more of: an author of the matching document; a publisher of the matching document; and a person or organisation identified, discussed, or mentioned in the matching document.

Identifying the at least one potential matching document may comprise one or more of: operating a crawler to identify content published online; periodically checking online data sources for new content; and subscribing to feeds from online data sources.

Determining whether the document is a match for the first document may comprise: comparing the document similarity score to a predefined threshold; and identifying the document as a matching document if the document similarity score is greater than the predefined threshold.

The document similarity score between the first identifier and the second identifier may be determined using a vector space similarity measurement.

The at least one potential matching documents may have an associated origin time and the document similarity score for each of the at least one potential matching documents may be determined in accordance with the respective origin time.

The method may further comprise providing the first document to the identified recipient. In this manner, the first document is provided to people who are likely to find it relevant or interesting.

Providing the first document to the identified recipient may comprise one or both of: sending the first document to the identified recipient; or notifying the identified recipient that the first document is available at a specified location.

Determining the first identifier may comprise determining a first term vector based on the content of the first document; and determining the second identifier may comprise determining a second term-vector based on the content of the document.

The first and second term-vectors may be determined using a term frequency-inverse document frequency (TF-IDF) algorithm.

The method may comprise storing the first identifier; and associating the stored first identifier with the first document.

Similarly, the method may comprise storing the determined second identifier; and associating the stored second identifier with the document.

The at least one potential matching document may be identified from content produced within a specified time frame; and/or the at least one potential matching document may be identified from content originating from one of a plurality of specified sources; and/or the at least one potential matching document may be identified from content determined to relate to a specified topic.

The at least one potential matching document may be published online. Additionally, the potential matching document may be an article published online. The first document is marketing material.

According to an aspect of the invention, there is provided a system for determining a similarity between a first document and a potential matching document, wherein the system comprises a processor that is configured to perform steps of: determining a first identifier associated with the first document; identifying at least one potential matching document; for each document of the at least one potential matching documents: determining a second identifier; and determining a document similarity score, the document similarity score being indicative of a similarity between the first identifier and the second identifier.

According to an aspect of the invention, there is provided a system for determining a similarity between a first document and a potential matching document, wherein the system comprises a processor that is configured to perform steps of: determining a first identifier associated with the first document; identifying at least one potential matching document; for each document of the at least one potential matching documents: determining a second identifier; and determining a document similarity score, the document similarity score being indicative of a similarity between the first identifier and the second identifier, determining, based on the similarity score, whether the document is a match for the first document; and if the document is determined to be a match for the first document, identifying a person associated with the matching document as a recipient for the first document.

According to an aspect of the invention, there is provided a system for determining a similarity between a first document and a potential matching document, the system comprising: first determining means for determining a first identifier associated with the first document; identifying means for identifying at least one potential matching document; second determining means configured to perform, for each document of the at least one potential matching documents, steps of: determining a second identifier; and determining a document similarity score, the document similarity score being indicative of a similarity between the first identifier and the second identifier.

According to an aspect of the invention, there is provided a system for determining a similarity between a first document and a potential matching document, the system comprising: first determining means for determining a first identifier associated with the first document; identifying means for identifying at least one potential matching document; second determining means configured to perform, for each document of the at least one potential matching documents, steps of: determining a second identifier; and determining a document similarity score, the document similarity score being indicative of a similarity between the first identifier and the second identifier, determining, based on the similarity score, whether the document is a match for the first document; and if the document is determined to be a match for the first document, identifying a person associated with the matching document as a recipient for the first document.

According to an aspect of the invention, there is provided a method of determining a similarity between a first document and a potential matching document, the method comprising: determining a first identifier associated with the first document; identifying at least one potential matching document; for each document of the at least one potential matching documents: determining a second identifier; determining, based on the first identifier and the second identifier, whether the document is a match for the first document; and if the document is determined to be a match for the first document, identifying a person associated with the matching document as a recipient for the first document.

According to an aspect of the invention, there is provided a non-transitory computer-readable medium comprising instructions which when executed perform a method of: determining a first identifier associated with the first document; identifying at least one potential matching document; for each document of the at least one potential matching documents: determining a second identifier; and determining a document similarity score, the document similarity score being indicative of a similarity between the first identifier and the second identifier, determining, based on the similarity score, whether the document is a match for the first document; and if the document is determined to be a match for the first document, identifying a person associated with the matching document as a recipient for the first document.

### DETAILED DESCRIPTION

The following disclosure is a description of one or more exemplary embodiments of the invention, which are not intended to be limiting on the scope of the appended claims.

In what follows, the term ‘document’ is used to describe any data, content, or material. For example, a document may comprise an article, a blog post, a twitter post, a comment posted on a website, a webpage, a statement etc.

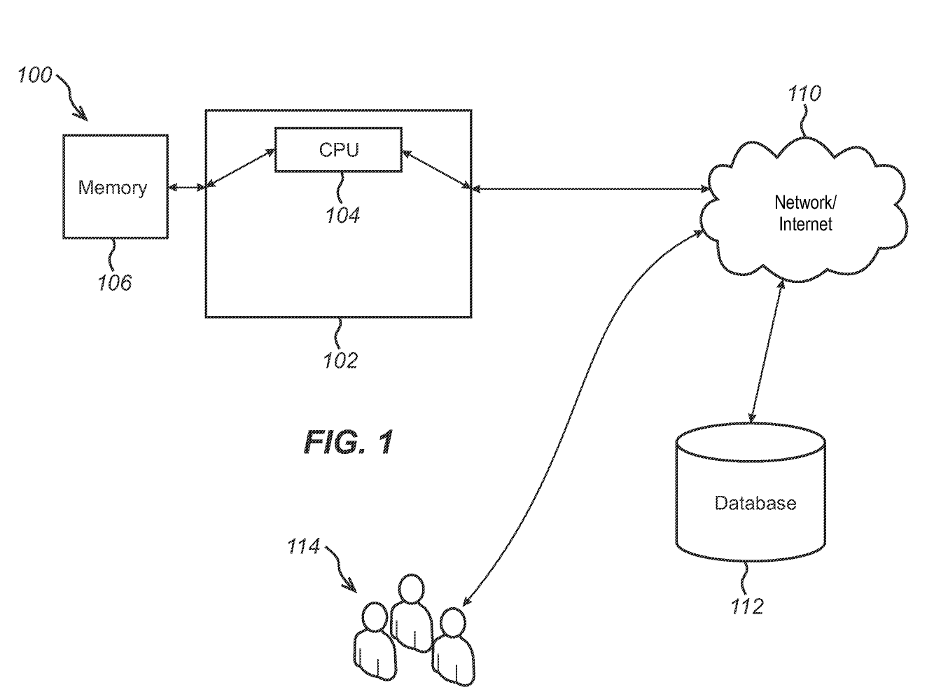

Reference is made to FIG. 1 which illustrates an exemplary system 100 which is usable in accordance with the disclosure below. The system 100 comprises an electronic device 102 comprising a processor 104 configured to carry out steps according to exemplary embodiments of the invention. The electronic device 102 may, for example, be a personal computer, a tablet, a smart phone, or any other suitable device.

The electronic device 102 may comprise a memory 106 in which the processor 104 stores data. Additionally or alternatively, the memory 106 may be external to the device 102. The electronic device 102 may then be configured to communicate via a wired or wireless connection with the memory 106.

The electronic device 102 may be configured to communicate with other devices. For example, the electronic device 102 may communicate with one or more devices 112 via a network 110. The network 110 may, for example, be a Local Area Network (LAN), the internet, or any other network across which the electronic device 102 can communicate with other devices. The network 110 may be a wired network or a wireless network.

In the exemplary embodiment of FIG. 1, the electronic device 102 communicates with one or more databases 112 across the internet 110. It will be appreciated that the databases 112 may comprise internet servers, in which data available or published on the internet is stored.

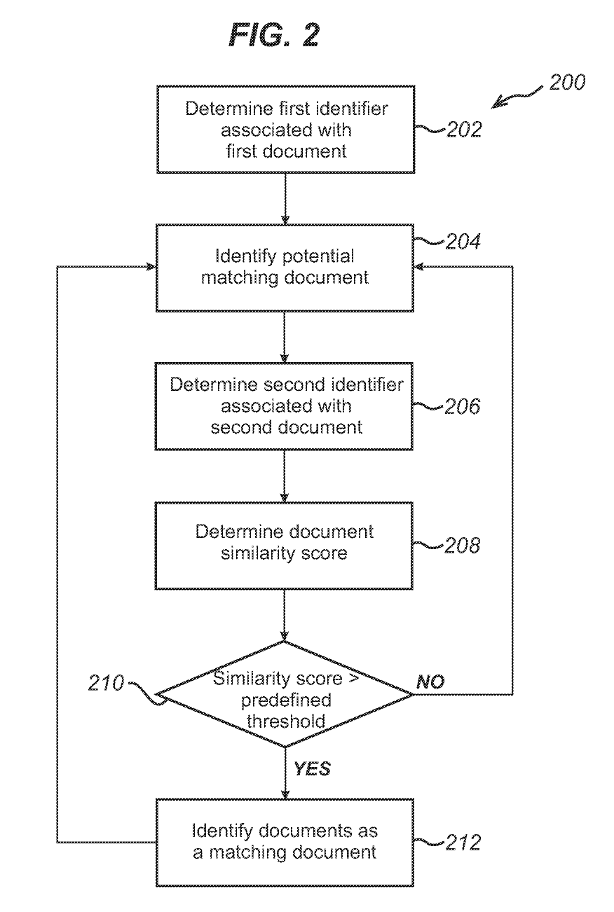

FIG. 2 is a flow chart depicting a method 200 of determining a similarity between a first document and a potential matching document. The first document may comprise any document or text to be used to find similar or matching documents. The first document may form part of an organisation's marketing collateral and may, for example, comprise a white paper, presentation, blog post or article, including information marketing a viewpoint, product or service of an organisation.

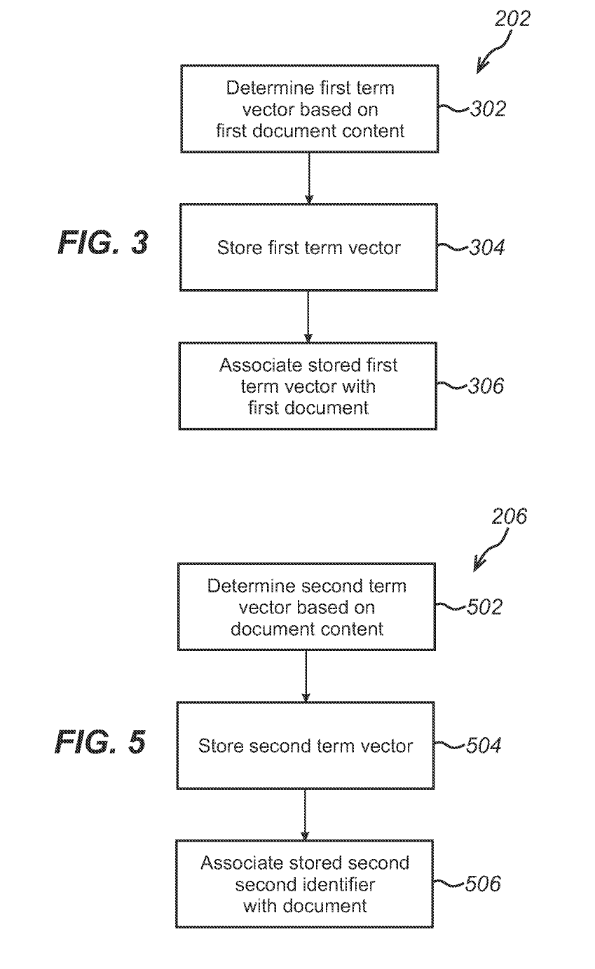

At block 202, the method 200 comprises determining a first identifier associated with the first document. The first identifier may be determined by any suitable means and this step is discussed in more detail with respect to FIG. 3.

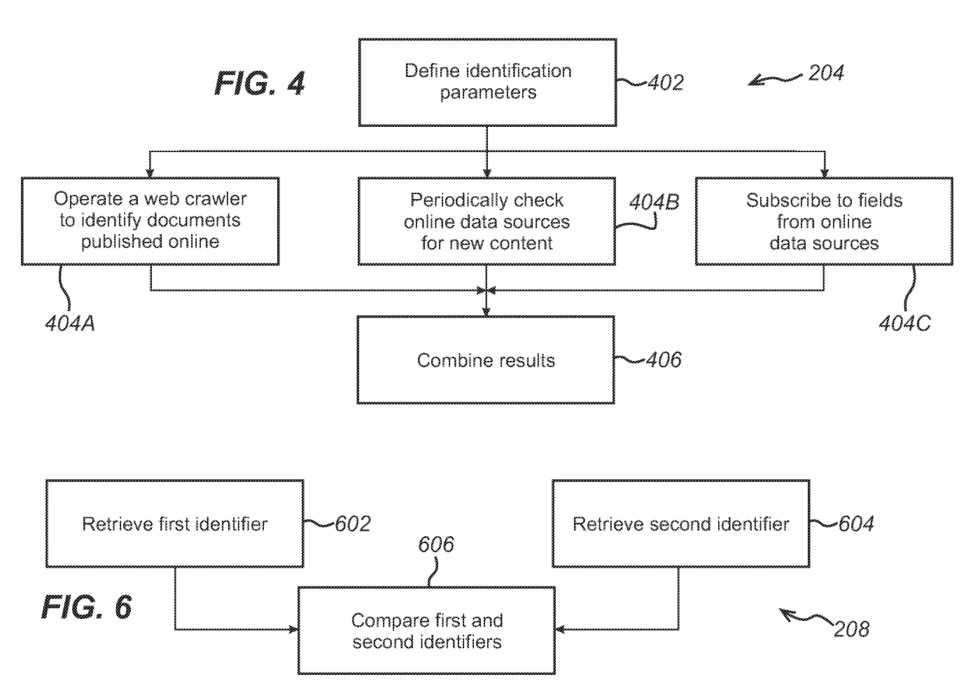

At block 204, the method 200 comprises identifying a potential matching document for the first document. The potential matching document may be identified by any suitable means and this step is discussed in more detail with respect to FIG. 4.

At block 206, the method 200 comprises determining a second identifier associated with the identified document. As with block 202, this determination may be performed by any suitable means and is discussed in more detail, with respect to FIG. 5.

At block 208, the method 200 comprises determining a document similarity score indicative of a degree of similarity between the first document and the identified potential matching document. The similarity score may be determined using any suitable means and is discussed in more detail with respect to FIG. 6.

At block 210, the method 200 comprises comparing the determined similarity score to a predefined threshold value. If the determined similarity score is greater than the predefined threshold value, processing continues at block 212 at which the method 200 comprises identifying the potential matching document as a matching document. This step may, for example, comprise saving a location at which the document is available, or some other suitable reference to the document, in the memory 106 or elsewhere.

The predefined threshold value may be selected or determined in accordance with any suitable criteria. It will be appreciated that selection of a higher threshold will result in fewer documents of higher similarity being identified as matching documents. Selection of a lower threshold, on the other hand, will result in a larger number of less similar documents being identified.

In an exemplary embodiment, the threshold may be changed in accordance with a desired number of matching documents. For example, the threshold may be selected such that the top 10% most similar potential matching documents are identified as matching documents. Alternatively, the threshold may be selected to be a number in the range of 0 to 1, for example 0.1, 0.15, 0.2 etc.

The steps performed at blocks 204 to 212 may then be repeated as required. For example, steps 204 to 212 may be repeated as long as further potential matching documents are identified. Additionally or alternatively, steps 204 to 212 may be repeated until a predefined number of potential matching documents have been identified.

After identifying a matching document, the source of the matching document is identified. The source may, for example, be a user 114 who wrote, compiled, or published the identified matching document, or any other user 114 that is identified as being associated with the identified matching document. The source is then identified as a possible recipient of the first document.

In an exemplary embodiment, the first document comprises product information and the identified matching document comprises comments posted by a blogger about the product. The comments posted by the blogger demonstrate the blogger's interest in the product and, accordingly, the blogger is identified as someone to whom the information will be provided. In this manner, the first document is provided only to those people who have demonstrated an interest in the information contained within the first document.

The first document may be provided to the identified source of the matching document by any suitable means. For example, the identified source may be sent a notification including the first document, or including a location at which the document can be accessed.

Such a notification may be e-mailed, sent by Short Message Service (SMS), internet messenger or by other suitable means. For example, the notification may be posted in a ‘comments’ section associated with the identified matching document. In this manner, the first document is provided to both the source of the identified matching document, and readers of the matching document.

In an exemplary embodiment, the identified source 114 may be a user that has previously subscribed to, or registered with, the system 100. In this case, the source 114 may be notified of the first document in accordance with user selected preferences stored during the subscription or registration process. Additionally or alternatively, on accessing or ‘logging on’ to the system 100, the user 114 may be presented with a pane comprising any notifications determined to be relevant for this user, i.e. one or more notifications relating to one or more ‘first documents’ determined to match documents originating from the user 114.

FIG. 3 is a flow chart depicting an exemplary method of determining a first identifier associated with the first document at block 202 of method 200. At block 302, the method 202 comprises determining a first term vector based on, or in accordance with, the content of the first document.

A term vector comprises values, each of which is associated with a respective word and is representative of the importance of the word in the document in which it occurs. In particular, each value represents the frequency with which a respective one of a list of keywords appears in a document, relative to the normal frequency with which the word appears in the language of the document. The term vector may be determined using any one of a number of well-documented algorithms, for example Term Count Model, Term Frequency-Inverse Document Frequency (TF-IDF), Bag-of-Words Model, Topic-based Vector Space Model, BM25 Ranking etc.

In an exemplary embodiment, the first term vector is determined using the TF-IDF algorithm, in which the term vector value, called the TF-IDF, associated with a word increases proportionally to the number of times the word appears in the document. This increase is offset by the frequency with which this word generally appears in the language of the document, or the frequency with which this word appears in a specified collection or corpus of documents.

The TF-IDF is the product of two statistics, term frequency and inverse document frequency. These statistics may be determined in any suitable way. For example, the term frequency tf(t,d) for a given keyword t may simply be the number of times the keyword t occurs in the document d.

The inverse document frequency idf(t,D) is a measure of whether the term is common or rare across all documents. It is obtained by dividing the total number of documents in the corpus or collection by the number of documents containing the term, and then taking the logarithm of that quotient. Mathematically the base of the log function does not matter and constitutes a constant multiplicative factor towards the overall result.

$$idf ( t , D ) = log \frac{\vert D \vert}{\vert \{ d ∈ D : t ∈ d \} \vert}$$

|D|: the total number of documents in the corpus
|{dεD:tεd}|: number of documents in the corpus in which the keyword t appears.

Then TF-IDF, or weight w(t, d₁, D), is calculated as:

w(t,d,D)=tf(t,d)×idf(t,D)

A high TF-IDF value is therefore determined if the associated keyword occurs with high frequency in the given document relative to the normal occurrence of the keyword in the language in the document (where the normal occurrence of the keyword in the language of the document is represented by the frequency with which the keyword occurs in the corpus).

The weight w(t,d,D) is calculated for each keyword and the resulting term vector can therefore be expressed as:

ν_{d}_{₁}_{=[w(1,d,D), w(2,d,D), . . . w(N,d,D)],}

where N is the total number of keywords considered for each document. Any suitable value of N may be used, for example 25, 50, 100, 150 etc.

Similarity matching based on this term vector will result in the identification of users 114 as potential recipients in a particular situation when they may have a very specific interest in the first document. For example, shortly after the user 114 has published an article on the subject of the first document.

In an exemplary embodiment, the TF-IDF scores w(t,d,D), t=1, . . . N, are normalized to a value between 1 and 0, where the maximum TF-IDF score for a document is set to 1.

Additionally or alternatively, the TF-IDF scores w(t,d,D), t=1, . . . N, may be weighted using a time factor indicative of the time and date at which the document was published. In this manner, recently published documents can be determined to be more relevant.

In an exemplary embodiment, the term vector ν can be created as a compound/average term-vector of all the documents published by a given source, for example a person or an organisation. In this embodiment, the identified potential recipients will be users 114 who, on average, should be most interested in the first document.

At block 304, the method 202 comprises operating the processor 104 to store the determined first identifier. For example, the processor 104 may store the determined first identifier in the memory 106. Additionally or alternatively, the processor 104 may store the determined first identifier in a memory accessible via the network 110, for example, in the database 112.

At block 306, the method 202 comprises operating the processor 104 to associate the stored first term-vector with the first document. The association may be made using any suitable means, for example the first term vector can be stored in the memory 106 or a database 112, wherein the identifier is stored in a table and associated with the first document.

FIG. 4 is a flow chart depicting an exemplary method for identifying a potential matching document at block 204.

At block 402, the method 204 comprises defining, or receiving an input defining, identification parameters. This step may, for example, comprise defining a time range wherein only documents published within the defined time range can be identified as a matching document. Additionally or alternatively, this step may comprise defined one or more sources of content (for example authors or organisations). In this case, only documents originating from the defined sources can be identified as a potential matching document. Other identifiable parameters are equally possible. For example, the potential matching documents may be identified from a subset of documents determined to mention a particular set of words or phrases. This subset of documents may, for example, be identified using a query or search based on the required words or phrases.

In a further example, at block 204 the method may comprise defining an issue. In this case, potential matching documents can only be identified if they relate to this topic, or if the source of the documents is associated with this topic. For example, if the issue of interest is identified to be ‘environment’, potential matching documents may be identified from documents published or written by known commentators or authorities on environmental issues.

After block 402, the method 204 comprises performing one or more of the steps described in relation to blocks 404A-C.

At block 404A, the method 204 comprises operating a web crawler, or ‘spidering’, to identify content published online that matches defined identification parameters. It is well known to use web crawlers for browsing the internet (or web) in a methodical, automated manner and any suitable crawler may be used at block 404A.

In an exemplary embodiment of the invention, the web crawler finds documents on the internet and indexes the documents found. For each document found, the web crawler stores the main text and links provided in the document. In an exemplary embodiment, the amount of data stored is reduced by storing a subset or representation of the documents found.

The web crawler then discovers new documents by following links to sites that have not previously been known and indexing the documents found at these sites in the manner described above.

At block 404B, the method 204 comprises periodically checking online data sources for new documents matching the defined identification parameters.

At block 404C, the method 204 comprises subscribing to feeds from online sources. For example RSS, ATOM and similar feeds may be subscribed to and checked to identify new documents matching the defined identification parameters.

At block 406, the method 204 comprises combining the results from the one or more of 404A-C that have been performed to identify one or more potential matching documents. Processing then resumes at block 206 of method 200.

FIG. 5 is a flow chart depicting an exemplary method of determining a second identifier based on the identified potential matching document at block 206 of method 200.

At block 502, the method 206 comprises operating the processor 102 to determine a second term vector based on the content of the identified potential matching document. As discussed above with respect to the first term vector, the second term vector may be determined by any suitable means including, but not limited to, TF-IDF.

Similar to block 304, at block 504, the method 206 comprises operating the processor 104 to store the second identifier. As with the first identifier, the second identifier may be stored in the memory 106 or any other suitable device such as the database 112.

Similar to block 306, at block 506, the method 206 comprises operating the processor 104 to associate the stored second identifier with the identified potential matching document. The association may be made using any suitable means including, but not limited to, storing the term-vector calculated for a potential matching web page in a database table together with a reference to the page for which the term-vector was calculated.

FIG. 6 is a flow chart depicting an exemplary method of determining similarity score for the identified potential matching document at block 208 of method 200.

At block 602, the method 208 comprises retrieving the first identifier from the memory in which it is stored.

At block 604, the method 208 comprises retrieving the second identifier from the memory in which it is stored.

The memory may comprise any memory such as a buffer memory, a local memory 106, a database 112 accessible via the internet, or any other memory suitable for storing the first and second identifiers. Similarly, the memory may be accessed by any suitable means.

It will be appreciated that, in certain embodiments, the step performed at block 606 may be performed directly after the steps of determining the first and second identifiers. In such cases, the first and second identifiers may not be stored in memory and, accordingly, blocks 602 and 604 will not be necessary. In such embodiments the method 208 simply comprises performing the step described below with respect to block 606.

At block 606, the method 208 comprises comparing the first identifier and the second identifier to determine a similarity score for the potential matching document associated with the second identifier.

The comparison of the first and second term identifiers may be performed using any suitable algorithm. For example, in the embodiments described in relation to FIGS. 3 and 5, in which the identifiers are term-vectors, the comparison between the first and second identifiers may be performed using vector comparison.

In an exemplary embodiment of the invention, the first and second term vectors are compared using cosine similarity (sometimes referred to as vector similarity), which comprises comparing the deviation of angles between the first and second term vectors.

In an exemplary embodiment in which the term vectors are calculated using TF-IDF, the cosine similarity can be calculated as:

$$sim ( {d}_{1} , {d}_{2} ) = \frac{{d}_{1} \cdot {d}_{2}}{‖ {d}_{1} ‖ ‖ {d}_{2} ‖} = \frac{{\sum }_{t = 1}^{N} w ( t , {d}_{1} , D ) w ( t , {d}_{2} , D )}{\sqrt{{\sum }_{t = 1}^{N} {w ( t , {d}_{1} , D )}^{2}} \sqrt{{\sum }_{t = 1}^{N} {w ( t , {d}_{2} , D )}^{2}}}$$

wherein d₁ is the first document and d₂ is the identified potential matching document and N is the total number of keywords considered when determining the term vectors. After computation of the similarity score for the potential matching document, processing continues at block 210 of method 200 at which the similarity score is compared to a threshold similarity value.

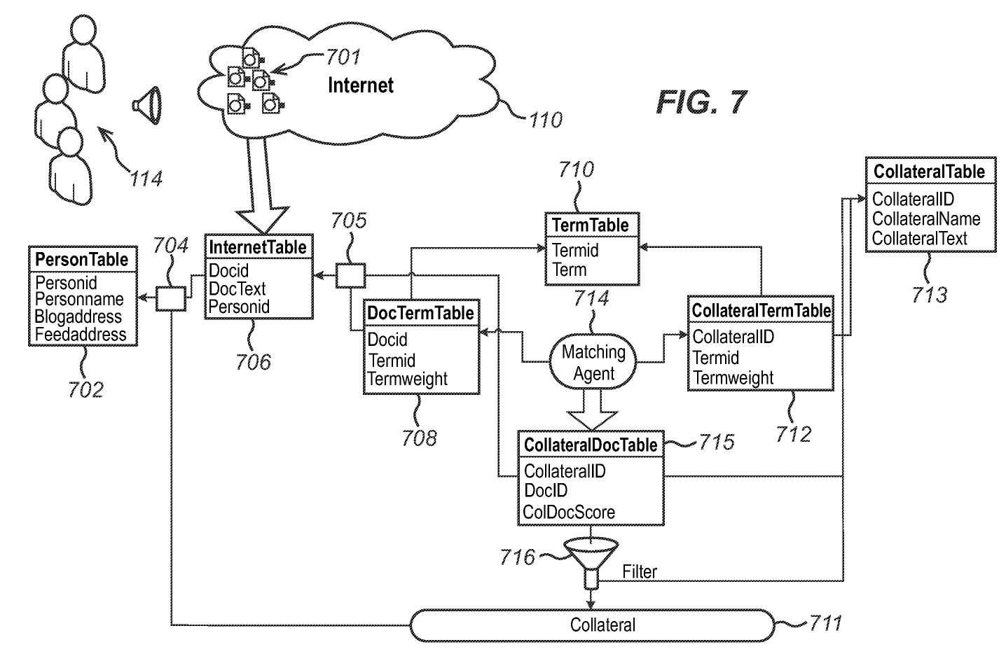

FIG. 7 is a schematic diagram of an exemplary embodiment of the invention.

An organisation that wishes to provide, or ‘send-out’ collateral 711, for example white papers, marketing information, presentations, reports, or any other type of documents or content, provides or uploads the collateral to the system 100. The organisations may provide the collateral 711 using any suitable means. For example, using an application (or ‘app’) running on a mobile device, via a web page, by emailing or otherwise sending, the collateral to a system administrator etc.

After the collateral 711 has been provided to the system 100, the collateral identification CollateralID, name CollateralName, and text or content CollateralText are stored in a database table CollateralTable 713. The CollateralTable 713 may be stored in any suitable memory, for example the local memory 106 and/or the database 112.

The system 100 then calculates an identifier, signature, or ‘fingerprint’ of the collateral 711. This identifier may be determined by calculating a collateral term vector for the collateral, for example by using the TF-IDF method described above. The collateral term vector is then stored in a CollateralTermTable 712 together with a reference to the associated collateral 711, i.e. the collateral from which it was determined. It will be appreciated that the CollateralTermTable 712 can be stored in any suitable memory, for example in a database 112 and/or the local memory 106.

People and organisations 114 publish content 701 such as statements, thoughts, articles and comments etc. that are accessible across the internet 110. For example, the content may be published as blog posts, tweets, comments on a forum, an article on a web page etc. As discussed with respect to FIG. 1, the content is stored in one or more databases or servers 112 that are connected to the internet 110.

The system 100 collects at least a portion of the published content by manually or automatically compiling information relating to the publishers of the content 701 and the locations of the published content. This information is then stored in a database table, PersonTable 702. It will be appreciated that the PersonTable 702 may be stored in one of the databases 112. Additionally or alternatively, the PersonTable 702 may be stored in the local memory 106 or any other suitable memory. The locations stored in the PersonTable 702 are then monitored and, when new content is published at the locations, the new content is collected by a software agent 704.

The system 100 then analyses the collected content to determine a similarity, or relevance, of the content with respect to the collateral provided by an organisation. In this manner, the system 100 identifies one or more content sources, for example publishers, authors or commentators, who are likely to be interested in the collateral. This analysis and determination is performed by a sequence of software agents 704, 705, 714.

The software agent 704 extracts the text from the newly collected content and stores the extracted text in a database table, InternetTable 706. It will be appreciated that the InternetTable 706 may be stored in one of the databases 112. Additionally or alternatively, the InternetTable 706 may be stored in a local memory 106 or any other suitable memory. A name or identification of the source 114 of the content 701 is stored in the PersonTable 702. The source identification is referenced by the InternetTable 706, thereby associating the content item 701 with the relevant source 114.

Accordingly, if the content 701 is determined to be similar, related or relevant to the subject matter of the collateral 711, the content source, or an individual or organisation referred to in the content, can be identified as a potential recipient of the collateral 711. In this manner, sources that have indicated an interest in, or are otherwise related to, the subject matter of the collateral 711, by publishing related content for example, can be provided with the collateral 711 which is likely to have a high degree of relevance to the source's interests.

The software agent 705 identifies a set of signature terms or keywords from the text extracted from the collected content. A term vector is then determined based on the identified terms. As discussed with respect to FIG. 5, the term vector may for example be determined using the TF-IDF algorithm.

The determined term vector corresponding to each item of content is stored in a database table, DocTermTable 708. It will be appreciated that the DocTermTable 708 may be stored in any suitable memory, for example the local memory 106 and/or the database 112.

The signature terms identified by the software agent 705 are stored in a database table, TermTable 710. As before, the TermTable 710 may be stored in any suitable memory, for example the local memory 106 and/or a database 112. A unique pointer to each term stored in the TermTable 710 is then obtained and the pointer is stored in the DocTermTable 708, together with the associated term vector value.

The software agent 714 then compares each term vector in DocTermTable 708 (i.e. the term vectors associated with the content 701) with the term vector stored in a CollateralTermTable 712 to determine a similarity score. As discussed previously, the similarity score may, for example, be determined using Cosine-Similarity. The similarity score (or similarity result) is then stored in the CollateralDocTable 715.

The similarity scores stored in the CollateralDocTable 715 are then filtered by filter 716. As discussed with respect to block 210 of method 200, this filtering may be performed by comparing each of the stored similarity scores to a predefined threshold. Alternatively, any other suitable method for filtering the results so as to obtain matches for each piece of collateral 711 may be used.

For example, very high similarity scores may indicate that the associated content 701 is a direct reference to the collateral 711, whilst low similarity scores may indicate that the content 701 is not very similar to the collateral 711. In this situation, the filter 716 may comprise a band-pass filter.

It will be appreciated that the filtering performed by the filter 716 may be performed before storing the similarity scores in the CollateralDocTable 715. In this case, the system 100 may store only the filtered similarity scores determined to correspond to matches for the collateral 711 in the CollateralDocTable 715.

Each time a matching document is identified the match can be tied back to both the identity of the matching document (docid which is stored in the InternetTable 706) and, via the reference between the InternetTable 706 and the PersonTable 702, to the publisher, source 114, or individual or organisation mentioned in the content. In this manner, a potential recipient of the collateral 711 is identified.

Once one or more potential recipients have been identified, the organisation providing the collateral 711 can notify the identified recipient that a piece of collateral exists that is likely to be of interest to the recipient. This notification can be performed manually and/or automatically. For example, an organisation may periodically check to see if the system 100 has identified a potential recipient and, if so, the organisation may then notify this recipient about the collateral.

The organisation may notify the identified recipient by providing the recipient with information on how the collateral can be obtained, for example by providing a web address or other location from which the collateral can be downloaded. Additionally or alternatively, the organisation may send the collateral 711 to the recipient, for example by email, SMS, instant messenger, a system notification etc. In an exemplary embodiment, potential recipients may be notified about the collateral 711 via an application or ‘app’ running on a user device.

It will be appreciated that the foregoing discussion relates to exemplary embodiments of the invention. However, in embodiments of the invention, the order in which steps are performed may be changed or one or more of the described steps may be omitted.

1. A method of determining a similarity between a first document and a potential matching document, the method comprising:
determining a first identifier associated with the first document;
identifying at least one potential matching document;
for each document of the at least one potential matching documents:
determining a second identifier;
determining a document similarity score, the document similarity score being indicative of a similarity between the first identifier and the second identifier;
determining, based on the similarity score, whether the document is a match for the first document; and
if the document is determined to be a match for the first document, identifying a person associated with the matching document as a recipient for the first document.

2. The method of claim 1, wherein identifying the at least one potential matching document comprises one or more of:
operating a crawler to identify content published online;
periodically checking online data sources for new content; and
subscribing to feeds from online data sources.

3. The method of claim 1, wherein determining whether the document is a match for the first document comprises:
comparing the document similarity score to a predefined threshold; and
identifying the document as a matching document if the document similarity score is greater than the predefined threshold.

4. The method of claim 1, wherein the document similarity score between the first identifier and the second identifier is determined using a vector space similarity measurement.

5. The method of claim 1, wherein the each of the at least one potential matching documents has an associated origin time and the document similarity score for each of the at least one potential matching documents is determined in accordance with the respective origin time.

6. The method of claim 2, wherein:
the person associated with the matching document is one or more of:
an author of the matching document;
a publisher of the matching document; and
a person or organisation referred to in the matching document.

7. The method of claim 1, further comprising:
providing the first document to the identified recipient.

8. The method of claim 7, wherein the providing comprises one or both of:
sending the first document to the identified recipient; or
notifying the identified recipient that the first document is available at a specified location.

9. The method of claim 10, wherein:
determining the first identifier comprises determining a first term vector based on the content of the first document; and
determining the second identifier comprises determining a second term-vector based on the content of the document.

10. The method of claim 9, wherein the first and second term-vectors are determined using a term frequency-inverse document frequency (TF-IDF) algorithm.

11. The method of claim 1, further comprising:
storing the first identifier; and
associating the stored first identifier with the first document.

12. The method of claim 9, further comprising:
storing the determined second identifier; and
associating the stored second identifier with the document.

13. The method of claim 1, wherein the at least one potential matching document is identified from content produced within a specified time frame; and/or
the at least one potential matching document is identified from content originating from one of a plurality of specified sources; and/or
the at least one potential matching document is identified from content determined to relate to a specified topic.

14. The method of claim 1, wherein the at least one potential matching document is published online.

15. The method of claim 1, wherein the first document is marketing material.

16. The method of claim 1, wherein the potential matching document is an article published online.

17. A system for determining a similarity between a first document and a potential matching document, wherein the system comprises a processor that is configured to perform steps of:
determining a first identifier associated with the first document;
identifying at least one potential matching document;
for each document of the at least one potential matching documents:
determining a second identifier; and
determining a document similarity score, the document similarity score being indicative of a similarity between the first identifier and the second identifier.

18. A system for determining a similarity between a first document and a potential matching document, the system comprising:
first determining means for determining a first identifier associated with the first document;
identifying means for identifying at least one potential matching document;
second determining means configured to perform, for each document of the at least one potential matching documents, steps of:
determining a second identifier; and
determining a document similarity score, the document similarity score being indicative of a similarity between the first identifier and the second identifier.

19. A method of determining a similarity between a first document and a potential matching document, the method comprising:
determining a first identifier associated with the first document;
identifying at least one potential matching document;
for each document of the at least one potential matching documents:
determining a second identifier;
determining, based on the first identifier and the second identifier, whether the document is a match for the first document; and
if the document is determined to be a match for the first document, identifying a person associated with the matching document as a recipient for the first document.

20. A non-transitory computer-readable medium comprising instructions which when executed perform a method of:
determining a first identifier associated with the first document;
identifying at least one potential matching document;
for each document of the at least one potential matching documents:
determining a second identifier; and
determining a document similarity score, the document similarity score being indicative of a similarity between the first identifier and the second identifier;
determining, based on the similarity score, whether the document is a match for the first document; and
if the document is determined to be a match for the first document, identifying a person associated with the matching document as a recipient for the first document.
